(19) United States
(12) Patent Application Publication
(10) Pub. No.: US 2012/0248673 A1
(43) Pub. Date: Oct. 4, 2012

(54) POINT-WELDING CLAMP

(76) Inventor: Yang Jen YUNG, Taichung City (TW)

(21) Appl. No.: 13/078,249

(22) Filed: Apr. 1, 2011

(51) Int. Cl. B25B 1/10

(52) U.S. Cl. 269/240

(57) ABSTRACT

A point-welding clamp for tightly clamping and locating different plate-shaped metal pieces to be welded together. The point-welding clamp includes a clamp section for clamping the plate-shaped metal pieces to be welded together, a drive section for controlling the clamping force applied to the plate-shaped metal pieces by the clamp section, and an abutment section including two abutment bodies. The abutment bodies are pivotally connected with the clamp section in abutment with the plate-shaped metal pieces. Each abutment body has an engagement face. The engagement faces of the abutment bodies serve to attach to the surfaces of the plate-shaped metal pieces to keep the force applied to the plate-shaped metal pieces by the clamp section normal to the surfaces of the plate-shaped metal pieces. Accordingly, it is ensured that the plate-shaped metal pieces are securely clamped by means of the point-welding clamp.

### BACKGROUND OF THE INVENTION

1. Field of the Invention

The present invention relates generally to a metal processing technique, and more particularly to a point-welding clamp.

2. Description of the Related Art

In the field of metal processing, different metal pieces are often connected with each other by means of welding. Prior to the welding operation, it is necessary to first fix the metal pieces to ensure that the metal pieces are welded together in their true relative positions.

FIG. 1 shows a conventional point-welding clamp 1 for fixing different metal plates in their true relative positions to facilitate welding operation. The point-welding clamp 1 includes a connection plate 2 inserted between two different metal plates to be fixed. A frame body 3 and a rectangular solid bar 4 are respectively disposed at two ends of the connection plate 2 for tightly clamping the metal plates and locating the metal plates. Such point-welding clamp 1 can be simply used to clamp and locate two metal plates in specific relative positions.

In practical metal welding process, the relative positions of different metal pieces are not limited to the above positions for the operation of the point-welding clamp. The metal pieces may be connected together in some other states. Therefore, the conventional point-welding clamp 1 can be hardly applied in different situations to clamp and locate different metal pieces.

### SUMMARY OF THE INVENTION

It is therefore a primary object of the present invention to provide a point-welding clamp for tightly clamping and locating different metal pieces to be welded so as to facilitate welding process.

To achieve the above and other objects, the point-welding clamp of the present invention includes: a clamp section including two elongated clamp arms, which are spaced from each other and arranged opposite to each other; a pivot section positioned between the clamp arms and between lengthwise top ends and bottom ends of the clamp arms, whereby the clamp arms can be pivotally rotated around the pivot section; a drive section for changing the distance between the lengthwise top ends of the clamp arms, when the drive section makes the distance between the lengthwise top ends of the clamp arms increase, the distance between the lengthwise bottom ends of the clamp arms being synchronously decreased, reversely, when the drive section makes the distance between the lengthwise top ends of the clamp arms decrease, the distance between the lengthwise bottom ends of the clamp arms being synchronously increased; and an abutment section including two abutment bodies pivotally disposed at the lengthwise bottom ends of the corresponding clamp arms by pivot shafts. Each abutment body has an engagement face. The engagement faces of the abutment bodies face each other.

The present invention can be best understood through the following description and accompanying drawings, wherein:

### BRIEF DESCRIPTION OF THE DRAWINGS

FIG. 1 is a perspective exploded view of a conventional point-welding clamp;

FIG. 2 is a perspective exploded view of a preferred embodiment of the point-welding clamp of the present invention;

FIG. 3 is a perspective assembled view of the preferred embodiment of the point-welding clamp of the present invention;

FIG. 4 is a perspective assembled view of the preferred embodiment of the point-welding clamp of the present invention, showing the use thereof;

FIG. 5 is a sectional view of the preferred embodiment of the point-welding clamp of the present invention, showing the use thereof in one state; and

FIG. 6 is a sectional view according to FIG. 6, showing the use of the point-welding clamp of the present invention in another state.

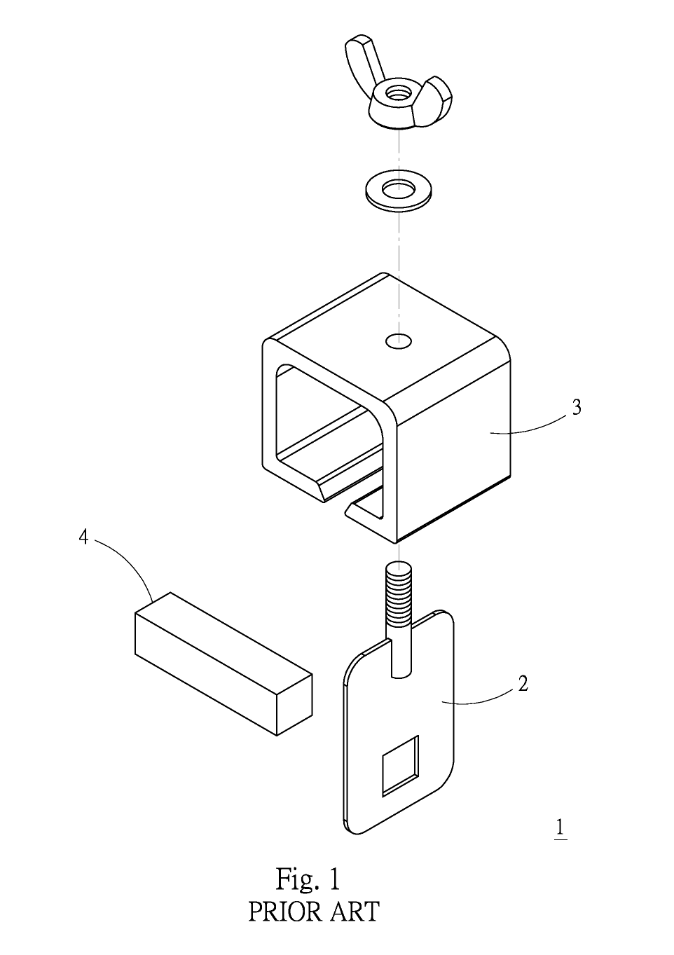

### DETAILED DESCRIPTION OF THE PREFERRED EMBODIMENT

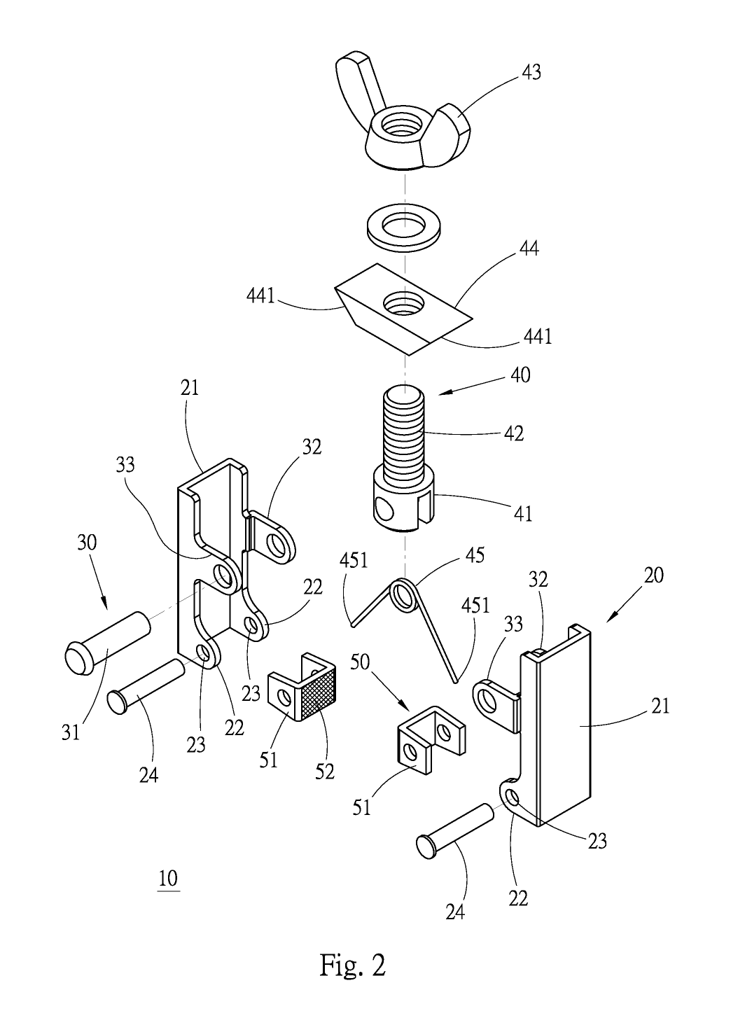

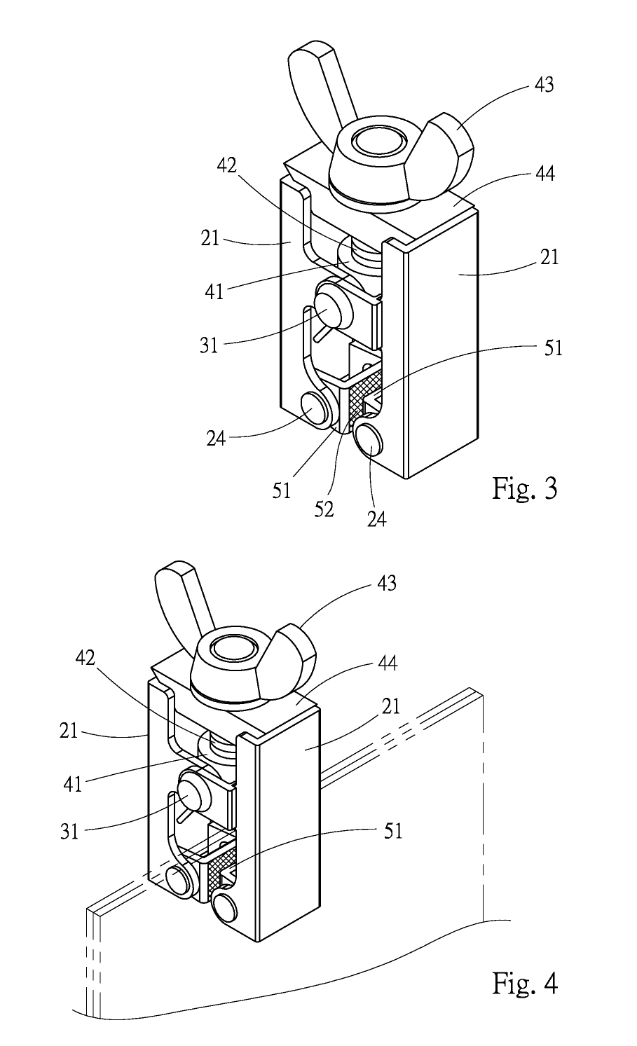

Please first refer to FIGS. 2 and 3. According to a preferred embodiment, the point-welding clamp 10 of the present invention includes a clamp section 20, a pivot section 30, a drive section 40 and an abutment section 50.

The clamp section 20 includes two elongated clamp arms 21 with substantially U-shaped cross section. The clamp arms 21 are spaced from each other and arranged opposite to each other. Each clamp arm 21 has a pair of lugs 22 respectively projecting from a free end and a second free end of the U-shaped clamp arm 21 at a lengthwise bottom end thereof. Each lug 22 has a through hole 23. Two pivot shafts 24 are respectively passed through the corresponding through holes 23 and bridged over the U-shaped openings of the lengthwise bottom end of the clamp arms 21.

The pivot section 30 is positioned between the clamp arms 21 and between lengthwise top ends and bottom ends of the clamp arms 21. Accordingly, the clamp arms 21 can be pivotally rotated around the pivot section 30. To speak more specifically, the pivot section 30 has a pivot pin 31 in parallel to the pivot shafts 24. The pivot section 30 further has a pair of first pivot arms 32 in the form of slats. Each first pivot arm 32 has a first end and a second end.

The second ends of the first pivot arms 32 are respectively perpendicularly fixedly connected with the first free ends of the U-shaped clamp arms 21. The first ends of the first pivot arms 32 are overlapped and pivotally connected with each other by means of the pivot pin 31. The pivot section 30 further has a pair of second pivot arms 33 in the form of slats. Each second pivot arm 33 has a first end and a second end. The second ends of the second pivot arms 33 are respectively perpendicularly fixedly connected with the second free ends of the U-shaped clamp arms 21. The first ends of the second pivot arms 33 are overlapped and pivotally connected with each other also by means of the pivot pin 31.

The drive section 40 is used to change the distance between the lengthwise top ends of the clamp arms 21 so as to urge the clamp section 20 to clamp two metal plates or release the metal plates. To speak more specifically, the drive section 40 has a pivot bushing 41 fitted on the pivot pin 31. The drive section 40 further has a threaded rod 42 positioned between the clamp arms 21 and having a top end and a bottom end. The bottom end of the threaded rod 42 is fixedly connected with the pivot bushing 41, while the top end of the threaded rod 42 extends out between the lengthwise top ends of the clamp arms 21. The drive section 40 further has a nut 43 screwed on the top end of the threaded rod 42, and a substantially trapezoidal push block 44 slidably disposed on the threaded rod 42 and positioned between the nut 43 and the lengthwise top ends of the clamp arms 21. The push block 44 has two oblique lateral faces 441 in abutment with inner sides of the lengthwise top ends of the clamp arms 21 respectively. The drive section 40 further has an elastic member 45 in the form of a spring. The elastic member 45 is fitted and located on the pivot pin 31. The elastic member 45 has two extension ends 451 in abutment with the inner sides of the clamp arms 21 between the pivot pin 31 and the pivot shafts 24 respectively.

The abutment section 50 includes two abutment bodies 51 with substantially U-shaped cross section. The abutment bodies 51 are respectively inlaid in the inner sides of the lengthwise bottom ends of the corresponding clamp arms 21 with their U-shaped openings facing the U-shaped openings of the clamp arms 21. The abutment bodies 51 are pivotally disposed on the corresponding pivot shafts 24. Two opposite engagement faces 52 of the abutment bodies 51 are respectively disposed on outer sides of opposite base sections of the U-shaped abutment bodies 51.

According to the above arrangement, the elastic member 45 of the drive section 40 serves to apply elastic force to the clamp arms 21 to elastically decrease the distance between the lengthwise top ends of the clamp arms. The push block 44 is embedded between the lengthwise top ends of the clamp arms 21 by a depth. The depth can be controlled to change the distance between the lengthwise top ends of the clamp arms 21. In other words, a user can screw the nut 43 to forcedly move the push block 44 downward and increase the depth by which the push block 44 is embedded between the lengthwise top ends of the clamp arms 21. Accordingly, the distance between the lengthwise top ends of the clamp arms 21 is increased to synchronously minify the distance between the lengthwise bottom ends of the clamp arms 21. Consequently, the engagement faces 52 are urged to get closer to each other.

FIGS. 4 to 6 show the use of the point-welding clamp 10 of the present invention. Two metal plates 61, 62 to be welded are first overlapped with each other and then together inserted between the abutment bodies 51. Then, by means of the drive section 40, the distance between the lengthwise bottom ends of the clamp arms 21 is minified until the engagement faces 52 tightly abut against the opposite faces of the metal plates 61, 62. Accordingly, by means of the point-welding clamp 10, the metal plates 61, 62 can be tightly securely engaged with each other to facilitate the point-welding operation.

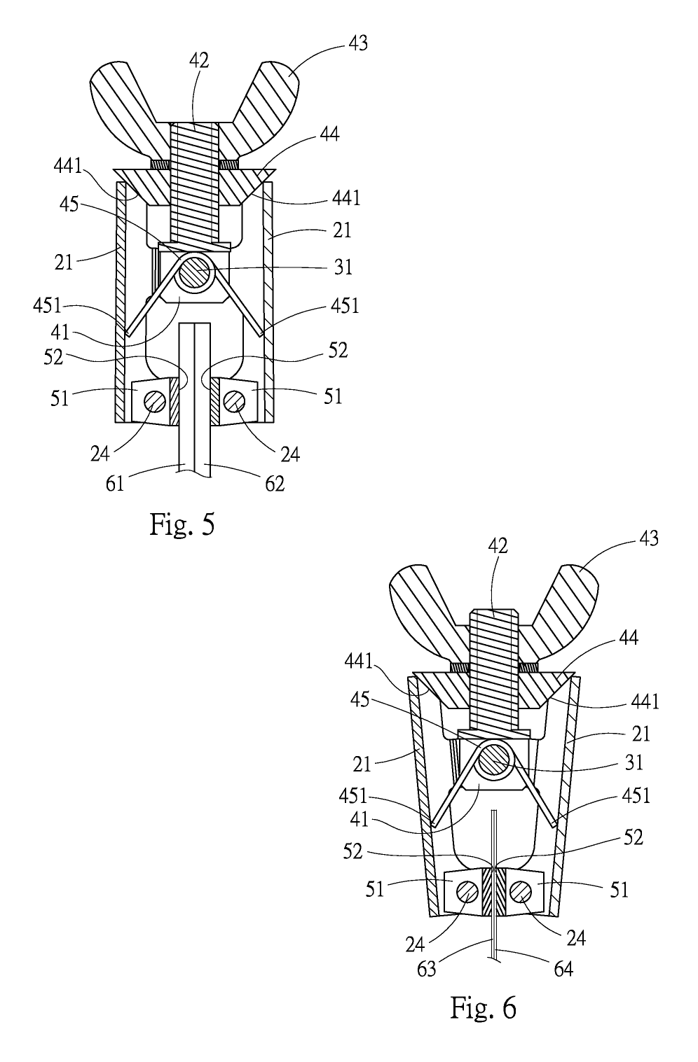

It should be noted that the thickness of the metal plates, which are tightly and securely clamped by the point-welding clamp 10 of the present invention, is not limited to a specific size. That is, the point-welding clamp 10 of the present invention has a wider application range. A user simply needs to screw the nut 43 to a different extent to change the distance between the lengthwise bottom ends of the clamp arms 21 for clamping the metal plates with different thickness. As shown in FIGS. 5 and 6, the point-welding clamp 10 of the present invention is applicable to thicker metal plates 61, 62 or thinner metal plates 63, 64 to clamp and locate the same in accordance with actual requirements in operation.

Furthermore, the clamp arms 21 are pivotally rotatable around the same pivot pin in an arcuate path. Therefore, when clamping the metal plates, the abutment bodies 51 must be pivotally rotated relative to the clamp arms 21 so as to keep the force applied to the faces of the metal plates by the engagement faces 52 normal to the faces of the metal plates. In this case, it is ensured that the metal plates are securely located by means of the point-welding clamp 10 without loosening.

The above embodiment is only used to illustrate the present invention, not intended to limit the scope thereof. Many modifications of the above embodiment can be made without departing from the spirit of the present invention.

What is claimed is:

1. A point-welding clamp comprising:
a clamp section including two elongated clamp arms, which are spaced from each other and arranged opposite to each other;
a pivot section positioned between the clamp arms and between lengthwise top ends and bottom ends of the clamp arms, whereby the clamp arms can be pivotally rotated around the pivot section;
a drive section for changing the distance between the lengthwise top ends of the clamp arms, when the drive section makes the distance between the lengthwise top ends of the clamp arms increase, the distance between the lengthwise bottom ends of the clamp arms being synchronously decreased, reversely, when the drive section makes the distance between the lengthwise top ends of the clamp arms decrease, the distance between the lengthwise bottom ends of the clamp arms being synchronously increased; and
an abutment section including two abutment bodies pivotally disposed at the lengthwise bottom ends of the corresponding clamp arms by pivot shafts, each abutment body having an engagement face, the engagement faces of the abutment bodies facing each other.

2. The point-welding clamp as claimed in claim 1, wherein the pivot section includes: a pivot pin; a pair of first pivot arms each having a first end and a second end, the second ends of the first pivot arms being respectively perpendicularly fixedly connected with the clamp arms, the first ends of the first pivot arms being pivotally connected with each other by means of the pivot pin; and a pair of second pivot arms each having a first end and a second end, the second ends of the second pivot arms being respectively perpendicularly fixedly connected with the clamp arms, the first ends of the second pivot arms being pivotally connected with each other also by means of the pivot pin.

3. The point-welding clamp as claimed in claim 2, wherein the drive section includes: a pivot bushing fitted on the pivot pin; a threaded rod having a top end and a bottom end, the bottom end of the threaded rod being fixedly connected with the pivot bushing, while the top end of the threaded rod extending out between the lengthwise top ends of the clamp arms; a nut screwed on the top end of the threaded rod; a push block slidably disposed on the threaded rod and positioned between the nut and the lengthwise top ends of the clamp arms, the push block having two lateral faces in abutment with the lengthwise top ends of the clamp arms respectively; and an elastic member for applying elastic force to the clamp arms to elastically decrease the distance between the lengthwise top ends of the clamp arms.

4. The point-welding clamp as claimed in claim 3, wherein the push block is in a trapezoid form.

5. The point-welding clamp as claimed in claim 1, wherein the pivot pin of the pivot section is parallel to the pivot shafts of the abutment bodies.

6. The point-welding clamp as claimed in claim 1, wherein the abutment bodies are positioned between opposite faces of the clamp arms.

7. The point-welding clamp as claimed in claim 1, wherein the clamp arms are plate-like bodies with U-shaped cross section and the abutment bodies are also plate-like bodies with U-shaped cross section, the abutment bodies being respectively inlaid in the corresponding clamp arms with their U-shaped openings facing U-shaped openings of the clamp arms.

8. The point-welding clamp as claimed in claim 7, wherein each of the abutment bodies has an engagement face disposed on a base section of the abutment body, the abutment bodies being arranged with the engagement faces opposite to each other.
